(19) United States
(12) Patent Application Publication
(10) Pub. No.: US 2007/0188075 A1
(43) Pub. Date: Aug. 16, 2007

(54) Field-emission electron source apparatus

(75) Inventors: Junichi Kimiya, Fujisawa-shi (JP); Keisuke Koga, Souraku-gun (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/706,532

(22) Filed: Feb. 13, 2007

(30) Foreign Application Priority Data
Feb. 15, 2006 (JP) 2006-038476

(51) Int. Cl. H01J 63/04; H01J 1/62

(52) U.S. Cl. 313/495

(57) ABSTRACT

A field-emission electron source apparatus includes a vacuum container that receives a field-emission electron source array, a target and an auxiliary electrode, and a getter pump that is disposed in the vacuum container and absorbs and removes excess gas. An electron beam emitted from the field-emission electron source array passes through a plurality of through holes formed in the auxiliary electrode and reaches the target. A space containing the field-emission electron source array and a space containing the target and the getter pump are separated substantially by the auxiliary electrode so that gas generated from the target is absorbed by the getter pump without passing through the space containing the field-emission electron source array. This makes it possible to provide a highly-reliable field-emission electron source apparatus in which the influence of gas and ions on the field-emission electron source array is eliminated or reduced.

### BACKGROUND OF THE INVENTION

1. Field of the Invention

The present invention relates to a field-emission electron source apparatus using a field-emission electron source.

2. Description of Related Art

In recent years, with the development of fine processing technology for semiconductors, attention has been directed to a vacuum microelectronics technology of integrating a large number of minute cold cathode structures on the order of micrometers on a semiconductor substrate or the like. Field-emission electron source arrays including the minute cold cathode structures obtained by such a technology achieve flat-type electron emission characteristics and a high electric current density, and do not require a heat source such as a heater, unlike hot cathodes, thus offering potential as electron sources for a low-power-consumption next-generation flat display, sensors and electron sources for a flat-type imaging apparatus.

As vacuum apparatuses using the field-emission electron source arrays described above, field-emission electron source display apparatuses shown in JP 9(1997)-270229 A, JP 9(1997)-69347 A, JP 6(1994)-111735 A and JP 2000-251808 A, field-emission electron source imaging apparatuses shown in JP 2000-48743 A, etc. and a light-emitting device shown in JP 2002-313263 A have been known.

In general, as shown in FIG. 13, such a field-emission electron source apparatus using a field-emission electron source array includes a front panel 101, a back panel 105 and a wall part 104, which are fixed firmly by a sealing material 109 such as frit glass or indium. An inner space of the field-emission electron source apparatus is maintained under vacuum.

An inner surface of the front panel 101 is provided with an anode electrode 102 transmitting incident light from outside, for example, and a surface of the anode electrode 102 is provided with a target 103. In general, the target 103 is a phosphor layer in which phosphors emitting three colors of light are arranged regularly when used as a field-emission electron source display apparatus and a photoelectric conversion film for converting incident light into a signal charge when used as a field-emission electron source imaging apparatus.

An inner surface of the back panel 105 is provided with a semiconductor substrate 106 on which a field-emission electron source array is formed. A plurality of cold cathode elements (emitters) 107 and peripheral elements 108 including an insulating layer formed so as to surround the individual cold cathode elements 107 and gate electrodes for applying a voltage for drawing electrons from the cold cathode elements 107 are integrated in the field-emission electron source array. Electron beams emitted from the cold cathode elements 107 are made to land on the target 103, whereby the phosphor can be caused to emit light so as to display an image in the field-emission electron source display apparatus and an image formed on the photoelectric conversion film by incident light can be read in the field-emission electron source imaging apparatus.

A representative example of the field-emission electron source generally can be a Spindt-type field-emission electron source in which cold cathode elements with a sharpened tip are formed on a semiconductor substrate, an insulating layer is formed around the cold cathode elements, gate electrodes are formed on the insulating layer, and a voltage is applied between the cold cathode elements and the gate electrodes, thereby emitting electrons from the tips of the cold cathode elements. Besides the above, examples thereof include field-emission electron sources of an MIM (metal insulator metal) type in which an insulating layer is formed between cathode electrodes and gate electrodes, and a voltage is applied to the insulating layer, thereby emitting electrons by a tunnel effect; those of an SCE (surface conduction electron source) type in which a minute gap is provided between cathode electrodes and emitter electrodes, and a voltage is applied between these electrodes, thereby emitting electrons from the minute gap; and those using a carbonaceous material such as DLC (diamond like carbon) or CNT (carbon nanotube) for an electron source.

In these field-emission electron sources including a cold cathode, the amount of electrons emitted from individual cold cathode elements is minute. Therefore, in the case where they are used as a field-emission electron source display apparatus or as a field-emission electron source imaging apparatus, unit cells each including a plurality of the field-emission electron sources (electron source cells) are formed, thus securing an amount of electric current necessary for performing a predetermined operation.

These cells are arranged on a flat surface, for example, in a matrix. More specifically, a plurality of emitter lines extending along a longitudinal direction are arranged at regular intervals in a transverse direction, a plurality of gate lines extending along the transverse direction are arranged at regular intervals in the longitudinal direction, and the cell is provided at each intersection of these plurality of emitter lines and gate lines. When driving the field-emission electron source apparatus, the emitter lines and the gate lines are selected sequentially, whereby an electron beam is emitted sequentially from the cell at the intersection of the emitter line and the gate line that are selected. In the instant specification, the cell that emits an electron beam as described above will be referred to as a “selected cell” in the following. In this manner, an image can be displayed in the field-emission electron source display apparatus, and a formed image can be read in the field-emission electron source imaging apparatus.

Since the field-emission electron source performs the field emission of electrons by a strong electric field formed between the cold cathode elements and the gate electrodes, the electrons are emitted from the individual cold cathode elements while having a predetermined divergence (the angle of this divergence is called a “divergence angle” and, for example, is about 300 in the case of the Spindt-type field-emission electron source).

Unlike the apparatus shown in FIG. 13, vacuum apparatuses using a field-emission electron source array in which a shield grid electrode is provided between the field-emission electron source array and a target are illustrated in JP 9(1997)-270229 A and JP 2000-48743 A.

FIG. 14 is a sectional view showing a field-emission electron source apparatus used as a field-emission electron source imaging apparatus illustrated in JP 2000-48743 A.

A vacuum container 118 includes a light-transmitting front panel 115, a back panel 117 and a wall part 116 also serving as a spacer portion for holding a meshed shield grid electrode 120. The front panel 115, the back panel 117 and the wall part 116 are fixed firmly by a sealing material 133 made of frit glass and a sealing material 119 made of indium. The inside of the vacuum container 118 is maintained under vacuum.

An inner surface of the front panel 115 is provided with a photoelectric conversion target 114 including an anode electrode 113 transmitting incident light 111 from outside and a photoelectric conversion film 112 formed on the surface of the anode electrode 113.

An inner surface of the back panel 117 is provided with a field-emission electron source array 129 including cold cathode elements 124, a cathode conductor 125 for supplying an electric potential to the cold cathode elements 124, an insulating layer 126 formed on the cathode conductor 125 so as to surround the cold cathode elements 124 and gate electrodes 128 disposed on the insulating layer 126 so as to surround the cold cathode elements 124.

The shield grid electrode 120 is disposed between the photoelectric conversion target 114 and the field-emission electron source array 129. The shield grid electrode 120 is supplied with a voltage higher than that applied to the gate electrodes 128.

The shield grid electrode 120 includes a plurality of through holes 120a.

The field-emission electron source apparatus illustrated in FIG. 14 has a problem described below.

As illustrated in FIG. 14, the insulating back panel 117 provided with the field-emission electron source array 129 and the front panel 115 provided with the photoelectric conversion target 114 opposed to this field-emission electron source array 129 are joined to each other with the wall part 116 interposed between their outer peripheral portions, such that the inside of the vacuum container 118 is maintained under high vacuum.

At this time, by providing frit glass having a low melting point serving as the sealing material 133 between the back panel 117 and the wall part 116 and burning it at about 400° C., the back panel 117 and the wall part 116 are attached to each other, so that the inside of the vacuum container is maintained airtight. Also, when the shield grid electrode 120 is positioned and fixed onto a step portion 121 of the wall part 116, frit glass having a low melting point is used. Therefore, the distance between the field-emission electron source array 129 and the shield grid electrode 120 depends on the thickness of the low-melting frit glass between the back panel 117 and the wall part 116 and that of the low-melting frit glass between the step portion 121 of the wall part 116 and the shield grid electrode 120.

Accordingly, variations are generated in the degree of parallelity and the distance between the field-emission electron source array 129 and the shield grid electrode 120.

As a result, the degree of divergence of the electron beam on the photoelectric conversion target 114 (focusing characteristics) varies for every field-emission electron source apparatus, or the degree of divergence of the electron beam varies depending on the position on the photoelectric conversion target 114 even within a single field-emission electron source apparatus. Thus, in the case where the field-emission electron source apparatus is used as a field-emission electron source imaging apparatus, a captured image varies for every apparatus, and partial variations occur in a captured image.

Moreover, the field-emission electron source apparatus illustrated in FIG. 14 has another problem described below.

That is, as shown in FIG. 14, a first space 135 containing the photoelectric conversion target 114 and a second space 136 containing the field-emission electron source array 129 are separated by the shield grid electrode 120. A surface of the back panel 117 opposite to the surface on which the field-emission electron source array 129 is formed is provided with a getter pump container 131 receiving a getter pump 132 for adsorbing and removing excess gas and ions in the vacuum container. A third space 137 containing the getter pump 132 inside the getter pump container 131 is connected to the second space 136 via a vent hole 130 formed in the back panel 117.

Thus, gas generated by irradiation of the photoelectric conversion target 114 with an electron beam and gas and ions emitted from peripheral glass members due to scattered electrons in the first space 135 containing the photoelectric conversion target 114 pass through the through holes 120a in the shield grid electrode 120 and the second space 136 and reach the third space 137 containing the getter pump 132. Accordingly, the gas from the photoelectric conversion target 114 and the gas and ions emitted from the peripheral glass members described above reach a peripheral portion of the cold cathode elements 124 during the driving, resulting in problems of deteriorating field-emission electron source array 129 due to the gas and ions, reducing field emission capability and further deteriorating withstand voltage characteristics such as the generation of discharge between individual electrodes.

These problems become particularly noticeable in a field-emission electron source imaging apparatus in which the target is provided with a photoelectric conversion film having an amorphous structure or the like.

### SUMMARY OF THE INVENTION

It is an object of the present invention to solve the above-described problems of the conventional field-emission electron source apparatus.

In other words, it is an object of the present invention to provide a highly-reliable field-emission electron source apparatus in which the influence of gas and ions on a field-emission electron source array is eliminated or reduced.

It is a further object of the present invention to provide a field-emission electron source apparatus that suppresses variations in an electron beam spot on a target.

A field-emission electron source apparatus according to the present invention includes a field-emission electron source array, a target for performing a predetermined operation using an electron beam emitted from the field-emission electron source array, and an auxiliary electrode that is disposed between the field-emission electron source array and the target and provided with a plurality of through holes through which the electron beam emitted from the field-emission electron source array passes.

A space containing the field-emission electron source array and a space containing the target and the getter pump are separated substantially by the auxiliary electrode so that gas generated from the target is absorbed by the getter pump without passing through the space containing the field-emission electron source array.

### BRIEF DESCRIPTION OF THE DRAWINGS

FIG. 1 is a sectional view showing a field-emission electron source apparatus according to Embodiment 1 of the present invention.

FIG. 2 is a schematic perspective view showing an auxiliary electrode used in the field-emission electron source apparatus according to Embodiment 1 of the present invention.

FIG. 3 is a partially enlarged perspective view showing through holes formed in a trimming portion of the auxiliary electrode used in the field-emission electron source apparatus according to Embodiment 1 of the present invention.

FIG. 4 is a partially enlarged sectional view taken along a thickness direction showing the trimming portion of the auxiliary electrode used in the field-emission electron source apparatus according to Embodiment 1 of the present invention.

FIG. 5 is an exploded perspective view showing the field-emission electron source apparatus according to Embodiment 1 of the present invention.

FIG. 6 is a sectional view showing an example of a field-emission electron source array in the field-emission electron source apparatus according to Embodiment 1 of the present invention.

FIG. 7 is a partially enlarged sectional view showing the field-emission electron source apparatus according to Embodiment 1 of the present invention.

FIG. 8 is a sectional view showing another field-emission electron source apparatus according to Embodiment 1 of the present invention.

FIG. 9 is a sectional view showing another field-emission electron source apparatus according to Embodiment 1 of the present invention.

FIG. 10 is a sectional view showing a field-emission electron source apparatus according to Embodiment 2 of the present invention.

FIG. 11 is a sectional view showing a field-emission electron source apparatus according to Embodiment 3 of the present invention.

FIG. 12 is a perspective view showing a wall part in the field-emission electron source apparatus according to Embodiment 3 of the present invention.

FIG. 13 is a sectional view showing a conventional field-emission electron source apparatus using a field-emission electron source array.

FIG. 14 is a sectional view showing another conventional field-emission electron source apparatus using a field-emission electron source array.

### DETAILED DESCRIPTION OF THE INVENTION

In accordance with the present invention, it is possible to provide a highly-reliable field-emission electron source apparatus in which the influence of gas and ions on a field-emission electron source array is eliminated or reduced.

Further, with the present invention, a field-emission electron source apparatus that suppresses variations in an electron beam spot on a target can be provided.

A field-emission electron source apparatus according to a first preferable mode of the present invention includes a field-emission electron source array, a target for performing a predetermined operation using an electron beam emitted from the field-emission electron source array, and an auxiliary electrode that is disposed between the field-emission electron source array and the target and provided with a plurality of through holes through which the electron beam emitted from the field-emission electron source array passes. The field-emission electron source apparatus further includes a vacuum container that receives the field-emission electron source array, the target and the auxiliary electrode, and a getter pump that is disposed in the vacuum container and absorbs and removes excess gas. A space containing the field-emission electron source array and a space containing the target and the getter pump are separated substantially by the auxiliary electrode so that gas generated from the target is absorbed by the getter pump without passing through the space containing the field-emission electron source array.

According to the first preferable mode described above, the auxiliary electrode substantially separates the space containing the field-emission electron source array and the space containing the getter pump. Owing to this configuration, gas and ions generated in a space other than the space containing the field-emission electron source array hardly influence the field-emission electron source array.

In other words, in the space in the vacuum container other than the space containing the field-emission electron source array, the target and other glass members are present. Electrons may impact on them so as to generate the gas and ions. Especially during driving the field-emission electron source apparatus, electrons in the electron beam emitted from the field-emission electron source array not only impact on the target but also become scattered and impact on the other glass members, causing the generation of gas and ions.

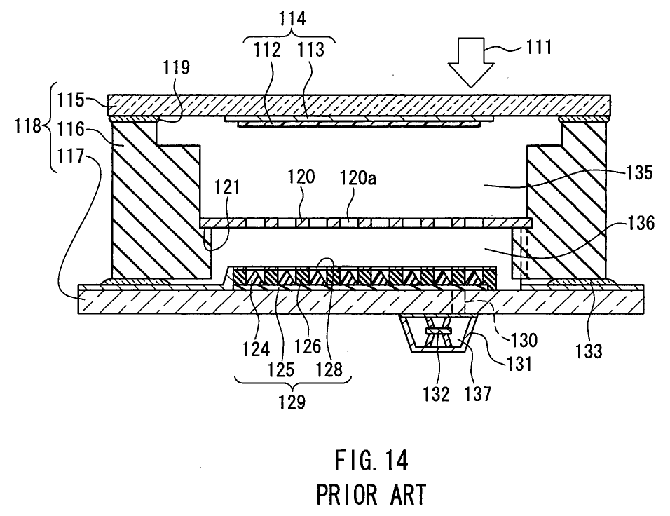

For example, the space in the vacuum container in the conventional field-emission electron source apparatus shown in FIG. 14 is separated by the shield grid electrode 120 fixed to the wall part 116 into the first space 135 containing the photoelectric conversion target 114 and the second space 136 containing the field-emission electron source array 129. The third space 137 inside the getter pump container 131 receiving the getter pump for adsorbing and removing excess gas in the vacuum container is connected to the second space 136 via the vent hole 130 formed in the back panel 117.

Thus, gas generated by irradiation of the photoelectric conversion target 114 with an electron beam and gas and ions emitted from peripheral glass members due to scattered electrons in the first space 135 always pass through the second space 136 before reaching the third space 137 containing the getter pump. Accordingly, these gas and ions are adsorbed by the field-emission electron source array 129, so that serious problems such as deteriorating emission characteristics may arise.

Also, the glass members such as the wall part 116 and the back panel 117 are exposed inside the second space 136 containing the field-emission electron source array 129. Accordingly, the gas and ions generated from these glass members are adsorbed by the field-emission electron source array 129 before reaching the third space 137 containing the getter pump, so that serious problems such as deteriorating emission characteristics may arise.

Further, ions generated by the impact of the electron beam or the scattered electrons on the photoelectric conversion target 114 or the peripheral glass members approach the vicinity of the field-emission electron source array 129, which may cause a problem in terms of withstand voltage characteristics, for example, discharge may occur between the cold cathode elements 124 and the gate electrodes 128.

On the other hand, in the first preferable mode of the present invention, the space containing the field-emission electron source array is separated substantially by the auxiliary electrode from the space containing the getter pump and the space containing the target and the exposed glass surface serving as major sources of gas and ions. Thus, the gas and ions generated from the target and the exposed glass surface can reach the space containing the getter pump without passing through the space containing the field-emission electron source array. Consequently, compared with the conventional field-emission electron source apparatus described above, it is possible to suppress the influence of the gas and ions generated in the vacuum container on the emission characteristics of the field-emission electron source array.

Also, dissociated ions generated by the impact of the electron beam or the scattered electrons on the target and the exposed glass surface are trapped or repelled by the auxiliary electrode maintained at a constant electric potential due to the electric charges of these ions. Therefore, it is difficult for the ions to pass through the through holes formed in the auxiliary electrode, enter the space containing the field-emission electron source array and reach the field-emission electron source array.

In this manner, the dissociated ions are prevented from approaching the field-emission electron source array, thereby making it possible to avoid the problems in terms of withstand voltage characteristics caused by the approach of the dissociated ions to the vicinity of the field-emission electron source array, for example, the discharge between the cold cathode elements and the gate electrodes or the discharge between the auxiliary electrode and the field-emission electron source array.

Then, this effect becomes more noticeable with an increase in the length of the electron beam passageway (namely, the thickness of the auxiliary electrode) relative to the opening diameter of the through hole. Accordingly, it is more preferable that the ratio of the length of the electron beam passageway to the opening diameter of the through hole is larger.

In a field-emission electron source apparatus according to a second preferable mode of the present invention, in the above-described first preferable mode, a substrate on which the field-emission electron source array is formed is provided further. The auxiliary electrode has a spacer portion that is formed as one piece with the auxiliary electrode and spaces out the field-emission electron source array and openings of the plurality of through holes from each other. The auxiliary electrode is provided on the substrate via the spacer portion.

According to the second preferable mode described above, in addition to the effect of the above-described first preferable mode, the distance between the field-emission electron source array and the opening in the auxiliary electrode on the side of the field-emission electron source array can be made to have less variation and set in a highly accurate manner. For example, in the conventional field-emission electron source apparatus illustrated in FIG. 14, the distance between the field-emission electron source array 129 and the shield grid electrode 120 varies due to three variations, i.e., attachment accuracy between the back panel 117 on which the field-emission electron source array -129 is formed and the wall part 116 (namely, thickness variations in the low-melting frit glass 133), attachment accuracy between the step portion 121 of the wall part 116 and the shield grid electrode 120 (namely, thickness variations in the low-melting frit glass) and production accuracy of the dimension from the lower surface of the wall part 116 attached to the back panel 117 to the step portion 121 (namely, dimensional variations).

On the other hand, in the second preferable mode of the present invention, since the auxiliary electrode has a spacer portion that is formed as one piece with the auxiliary electrode, the distance between the field-emission electron source array and the opening of the auxiliary electrode on the side of the field-emission electron source array varies due to two variations, i.e., attachment accuracy between the field-emission electron source array and the spacer portion and production accuracy of the thickness of the spacer portion (namely, dimensional variations). In other words, the portion attached by the low-melting frit glass, which involves the poorest accuracy, is not present. Therefore, the accuracy in the distance between the field-emission electron source array and the opening of the auxiliary electrode on the side of the field-emission electron source array improves.

Also, in accordance with the second preferable mode of the present invention, the mechanical strength of the auxiliary electrode improves.

In other words, assuming a 1-inch-diagonal (outer size) field-emission electron source imaging apparatus for capturing a VGA (640 dots×480 dots, horizontally by vertically), for example, one pixel has a size of about 0.02 mm. In view of the function of the auxiliary electrode, it is considered appropriate that the thickness of the auxiliary electrode should be about 1 to 10 times the size of one pixel and therefore about 0.02 to 0.2 mm. The dimension of the auxiliary electrode is slightly larger than 12 mm×10 mm. Considering the fact that this auxiliary electrode is provided with a large number of through holes, the auxiliary electrode has a very low mechanical strength. Thus, it is very difficult to handle the auxiliary electrode itself during a process of assembling a field-emission electron source apparatus due to its insufficient mechanical strength.

However, in the second preferable mode of the present invention, the auxiliary electrode has the frame-like spacer portion that is formed as one piece with and on the periphery of the auxiliary electrode. Accordingly, since the spacer portion improves the mechanical strength of the auxiliary electrode, this solves the problem of the auxiliary electrode itself being difficult to handle in the process of assembling a field-emission electron source apparatus.

In a field-emission electron source apparatus according to a third preferable mode of the present invention, in the above-described second preferable mode, the spacer portion and the substrate are joined using an electrically conductive material, and a voltage is supplied to at least part of the auxiliary electrode from the substrate via the electrically conductive material.

According to the third preferable mode described above, it becomes possible to supply a voltage to the auxiliary electrode from the substrate on which the field-emission electron source array is formed, thus eliminating the need for wire bonding for supplying the voltage. Thus, the cost for wire bonding can be saved, and failures such as fallen wires can be avoided in the case of wire bonding.

The following is a specific description of the present invention by way of illustrative embodiments.

### Embodiment 1

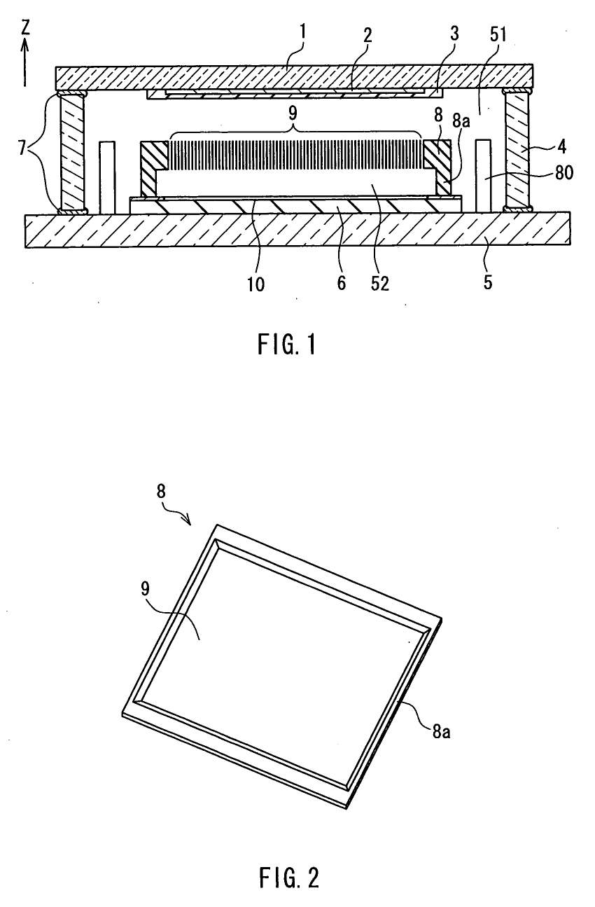

FIG. 1 is a sectional view showing a field-emission electron source apparatus according to Embodiment 1 of the present invention.

As shown in FIG. 1, a field-emission electron source apparatus according to Embodiment 1 of the present invention is provided with a vacuum container including a front panel 1 formed of a light-transmitting glass member, a back panel 5 and a wall part 4. Using a vacuum sealant 7, for example, frit glass for high-temperature burning or indium for low-temperature sealing, the front panel 1 and the wall part 4 are fixed firmly and sealed, and the back panel 5 and the wall part 4 are fixed firmly and sealed, so that the inside of the vacuum container is maintained under vacuum. For convenience of description in the following, an axis parallel with a direction normal to the front panel 1 and the back panel 5 is referred to as a Z axis.

An inner surface of the back panel 5 is provided with a semiconductor substrate 6 on which a field-emission electron source array 10 is formed. An auxiliary electrode 8 with which a spacer portion 8a is formed as one piece is placed on and fixed to the semiconductor substrate 6. An inner surface of the front panel 1 opposed to the auxiliary electrode 8 is provided with a light-transmitting anode electrode 2 and a target 3. The target 3 is a layer for receiving electrons emitted from the field-emission electron source array and performing a predetermined beneficial operation and, for example, is a phosphor layer or a photoelectric conversion film.

Inside the vacuum container formed of the front panel 1, the back panel 5 and the wall part 4, a getter pump 80 is provided for adsorbing and removing an excess gas so as to maintain the inside under high vacuum.

FIG. 2 is a schematic perspective view showing the auxiliary electrode 8 viewed from a surface opposed to the field-emission electron source array. The auxiliary electrode 8 is a substantially flat electrode including a thin trimming portion 9 at the center and the frame-like spacer portion 8a that is connected to a periphery of the trimming portion 9 and thicker than the trimming portion 9. The trimming portion 9 is provided with a plurality of through holes.

The spacer portion 8a has a function of improving the mechanical strength of the auxiliary electrode 8 itself and a function of spacing out the field-emission electron source array and openings of the plurality of through holes formed in the trimming portion 9 and maintaining the distance between them in a highly accurate manner.

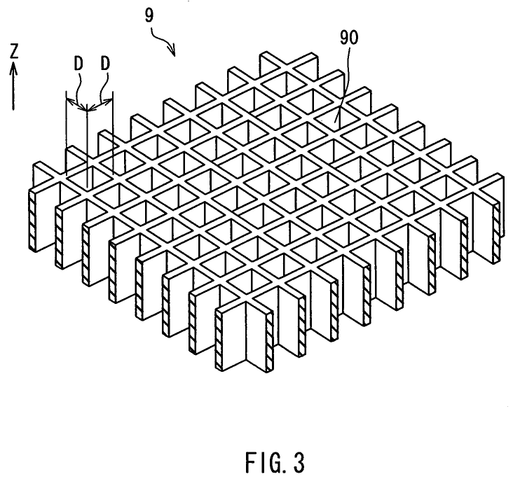

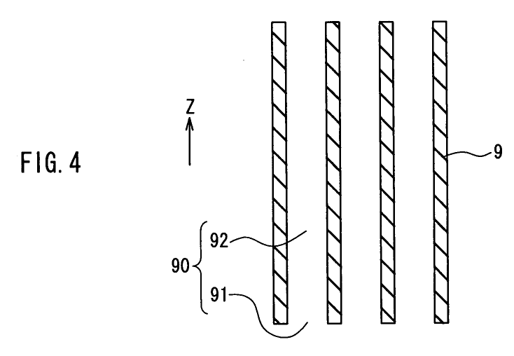

FIG. 3 is a partially enlarged perspective view showing the trimming portion 9 of the auxiliary electrode 8. The trimming portion 9 is provided with a large number of through holes 90 connecting front and back surfaces of the trimming portion 9, and through which electron beams emitted from the field-emission electron source array pass. These large number of through holes 90 are arranged like lattice points.

FIG. 4 is a partially enlarged sectional view along a Z-axis direction showing the trimming portion 9. Each of the through holes 90 has an opening 91 that is formed on the surface of the trimming portion 9 on the side of the field-emission electron source array and an electron beam passageway 92 that continues from the opening 91 along the thickness direction of the trimming portion 9. In the instant specification, the opening 91 means a portion of the through hole 90 included at the surface of the trimming portion 9 on the side of the field-emission electron source array and does not include a Z-axis direction component. Also, the electron beam passageway 92 means a portion of the through hole 90 between the front and back surfaces of the trimming portion 9.

The length of the electron beam passageway 92 is sufficiently larger than a diameter D of the opening 91. Here, the length of the electron beam passageway 92 means the length along the electron beam passageway 92. Therefore, in the case where the electron beam passageway 92 is bent, the length of the electron beam passageway 92 is larger than the thickness of the trimming portion 9 along the Z-axis direction.

The length of the electron beam passageway 92 is sufficiently larger than the diameter D of the opening 91, whereby a partial electron beam of the electron beam emitted from the field-emission electron source array, which travels in a direction that forms a large angle with the direction along which the electron beam passageway 92 extends (the Z-axis direction in the present embodiment), can be made to impact on and be absorbed and removed by a lateral wall of the electron beam passageway 92. For example, when the diameter D of the opening 91 is 16 μm and the length of the electron beam passage way 92 is 100 μm, the partial electron beam that travels in the direction that forms an angle of about 9.2° or larger with the Z-axis can be made to impact on and be absorbed and removed by the lateral wall of the electron beam passageway 92.

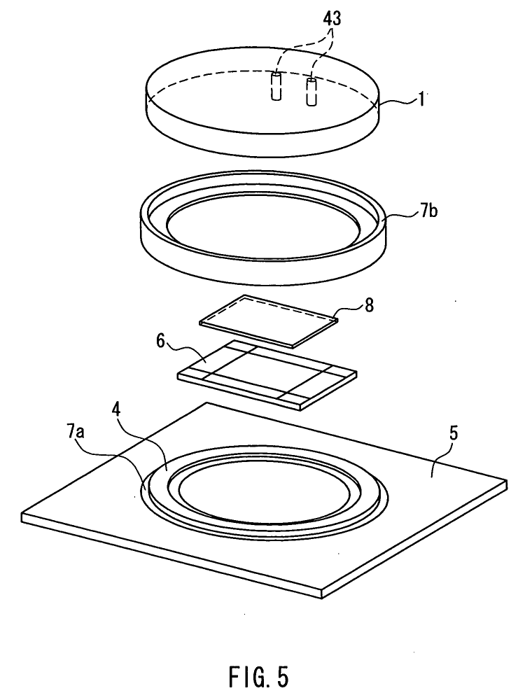

FIG. 5 is an exploded perspective view showing the field-emission electron source apparatus according to Embodiment 1 of the present invention. Referring to FIG. 5, an exemplary method for assembling the field-emission electron source apparatus will be described briefly.

A frit glass 7a is provided on the back panel 5, and an annular wall part 4 is placed thereon, followed by burning at a temperature as high as about 400° C. Thus, the back panel 5 and the wall part 4 are joined via the frit glass 7a.

The spacer portion 8a of the auxiliary electrode 8 and the semiconductor substrate 6 are joined by a joint technique, for example, anodic bonding or eutectic bonding. The semiconductor substrate 6 on which the auxiliary electrode 8 is mounted is placed on and fixed to a portion on the back panel 5 surrounded by the wall part 4 by die bonding.

A voltage is supplied to the trimming portion 9 from the semiconductor substrate 6 via the portion where the spacer portion 8a of the auxiliary electrode 8 and the semiconductor substrate 6 are joined and the spacer portion 8a. A wiring pattern on the semiconductor substrate 6 for supplying a voltage to the auxiliary electrode 8 is connected to a wiring pattern formed on the back panel 5 by wire bonding (not shown). In this way, it is possible to supply a voltage to the auxiliary electrode 8 from outside of the vacuum container.

On the semiconductor substrate 6, the field-emission electron source array in which a plurality of cells are arranged in a matrix is formed. Each cell includes a plurality of (for example, 100) cold cathode elements (emitters).

The plurality of cells in the field-emission electron source array on the semiconductor substrate 6 and the plurality of through holes 90 of the auxiliary electrode 8 are in a one-to-one correspondence with each other. The semiconductor substrate 6 and the auxiliary electrode 8 are aligned in a highly accurate manner such that an axis that passes through the center of each cell and is parallel with the Z axis passes through the substantial center of the through hole 90 of the auxiliary electrode 8 corresponding to this cell (in the present embodiment, for example, such that a displacement amount of the center of the through hole 90 with respect to the axis that passes through the center of the cell and is parallel with the Z axis is not greater than about 3 μm).

A back panel structure constituted by the back panel 5, the wall part 4, the auxiliary electrode 8 and the semiconductor substrate 6 assembled as above is subjected to bakeout for degassing at about 120° C. to 350° C. in a vacuum apparatus.

After the bakeout, the back panel structure is joined to and formed as one piece with the front panel 1 in a vacuum by a metal ring 7b to which indium has been applied, thus forming a vacuum container whose inner portion is vacuum-sealed.

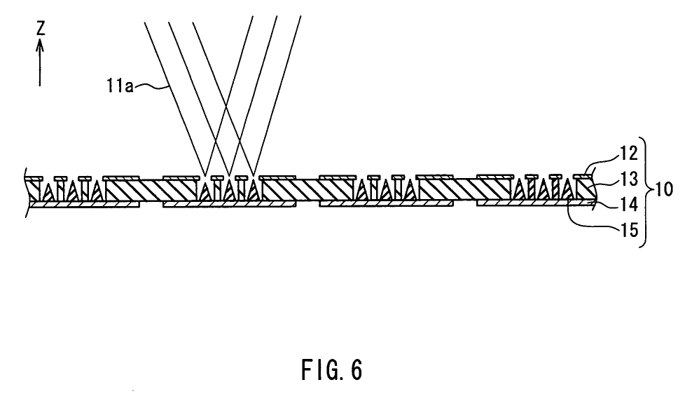

As shown in FIG. 6, the field-emission electron source array formed on the semiconductor substrate 6 is formed by integrating a large number of emitter portions including cold cathode elements (emitters) 15 with a sharpened tip, an insulating layer 13 formed around the cold cathode element 15 and gate electrodes 12 that are disposed on the insulating layer 13 and provided with openings surrounding the cold cathode elements 15, etc.

In a flat-type imaging apparatus for capturing a VGA (640 dots×480 dots, horizontally by vertically) image, for example, the field-emission electron source array includes cells, each having a longitudinal dimension of about 20 μm and a transverse dimension of about 20 μm, arranged respectively at the pixel positions that are arranged in a matrix. A plurality of the gate electrodes 12 are formed as stripes extending in a horizontal direction (or a vertical direction), and a plurality of emitter electrodes 14 are formed as stripes extending in a direction perpendicular to a longitudinal direction of the gate electrodes 12. When viewed from a direction parallel with the Z axis, a single cell is provided at each of the intersections of the plurality of gate electrodes 12 and the plurality of emitter electrodes 14. In each cell, a plurality of the cold cathode elements 15 are arranged in such a manner as to be distributed substantially evenly within a region on the emitter electrode 14 with a longitudinal dimension of about 10 μm and a transverse dimension of about 10 μm.

The plurality of cold cathode elements 15 in a single cell are supplied with a pulsed emitter potential that drops from a reference potential of 30 V to 0 V, for example, and the gate electrodes 12 formed on the insulating layer 13 surrounding the cold cathode elements 15 are supplied with a pulsed gate potential that rises from a reference potential of 30 V to a middle potential of 60 V, for example. A potential difference formed between the cold cathode element 15 and the gate electrode 12 causes electrons to be emitted from the tip of the cold cathode element 15.

The gate electrodes 12 and the emitter electrodes 14 are connected to a wiring pattern formed on the back panel 5 so as to connect an inside and an outside of the vacuum container. The emitter potential applied to the cold cathode elements 15 and the gate potential applied to the gate electrodes 12 are supplied from the outside of the vacuum container via this wiring pattern.

The auxiliary electrode 8 is supplied with a middle voltage of about 150 to 500 V that is a little higher than a maximum voltage applied to the gate electrodes 12. The distance from the field-emission electron source array to the surface of the plurality of through holes formed in the trimming portion 9 of the auxiliary electrode 8 on the side of the field-emission electron source array is about 100 μm.

When the voltage to be applied to the auxiliary electrode 8 is too high, a problem with withstand voltage characteristics between the auxiliary electrode 8 and the field-emission electron source array may occur. Further, in the case where the field-emission electron source apparatus is used as a field-emission electron source imaging apparatus, withstand voltage characteristics between the auxiliary electrode 8 and the target 3 also may become a problem. Conversely, when the voltage to be applied to the auxiliary electrode 8 is too low, an effect of accelerating an electron beam emitted from the field-emission electron source array diminishes, thus increasing the divergence angle of the electron beam. Accordingly, an amount of the electron beam passing through the auxiliary electrode 8 decreases, so that there is a possibility that the amount of electric current of the electron beam is insufficient. Accordingly, the inventors of the present invention experimentally confirmed that a preferred value of the voltage to be applied to the auxiliary electrode 8 was in the above-noted range.

The target 3 is spaced from the auxiliary electrode 8 by about 150 μm to several hundred micrometers. The transparent anode electrode 2 is formed between the front panel 1 and the target 3. The anode electrode 2 is supplied with a high voltage of, for example, about several hundred volts to several kilovolts that is higher than the voltage to be applied to the auxiliary electrode 8 via electrodes 43 penetrating through the front panel 1 (see FIG. 5).

When predetermined voltages respectively are applied to the cold cathode elements 15 and the gate electrodes 12 in the field-emission electron source array, electron beams 11a are emitted from the cold cathode elements 15. The electron beam 11a enters the opening 91 of the through hole 90 in the auxiliary electrode 8 about 100 μm in thickness spaced from the field-emission electron source array in the Z-axis direction by about 100 μm and passes through the electron beam passageway 92 continuing from the opening 91. Then, an electron beam 11b that has left the auxiliary electrode 8 reaches the target 3 that is spaced from the auxiliary electrode by about 150 μm to several hundred micrometers.

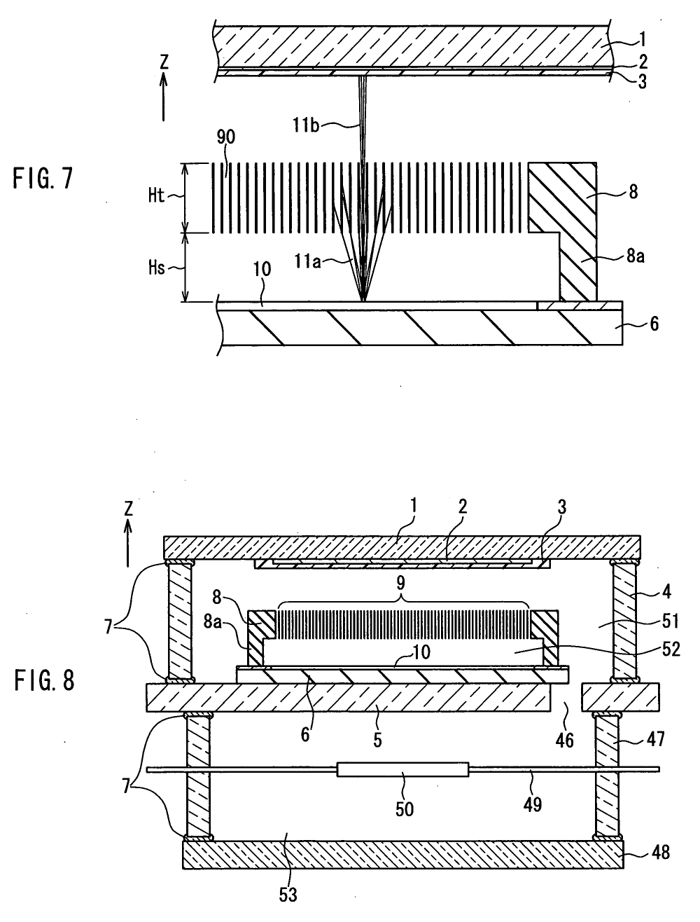

As shown in FIG. 7, the electron beam 11a emitted from a single cell (selected cell) in the field-emission electron source array travels toward the auxiliary electrode 8 while having a predetermined divergence angle and enters the plurality of through holes 90 formed in the auxiliary electrode 8.

In the electron beam 11a emitted from the selected cell, the partial electron beam that has traveled obliquely with respect to the Z axis and entered the through holes 90 located at positions away from a straight line that passes through this selected cell and is parallel with the Z axis impacts on and is absorbed and removed by the lateral walls of the electron beam passageways 92 of these through holes 90.

On the other hand, in the electron beam 11a emitted from the selected cell, the partial electron beam that has traveled substantially in parallel with the Z axis and entered the through hole 90 located on the straight line that passes through this selected cell and is parallel with the Z axis (in the following, this through hole will be referred to as the “through hole corresponding to the selected cell”) passes through the electron beam passageway 92 extending in parallel with the Z axis, leaves the auxiliary electrode 8 and reaches the target 3. This electron beam 11b that has left the auxiliary electrode 8 has a small divergence angle and a substantially aligned traveling direction, so that the cross-sectional area thereof in a direction perpendicular to the traveling direction will not expand in the course of reaching the target 3.

As described above, in the field-emission electron source apparatus according to Embodiment 1 of the present invention, the electron beam 11b having a smaller divergence angle compared with the case of providing no auxiliary electrode 8 can be permitted to reach the target 3. Therefore, it is possible to reduce the spot diameter of the electron beam on the target 3. Thus, a high-definition image can be displayed in a field-emission electron source display apparatus in which the target is provided with a phosphor, and a high-definition image can be captured in a field-emission electron source imaging apparatus in which the target is provided with a photoelectric conversion film.

Also, since the electron beam 11b that has left the auxiliary electrode 8 has a small divergence angle, the spot diameter of the electron beam on the target 3 hardly varies even if the distance between the back panel 5 and the front panel 1 varies due to an assembly error or even if the back panel 5 and/or the front panel 1 is warped and deformed due to atmospheric pressure, for example. Thus, it is possible to provide a field-emission electron source display apparatus capable of displaying a uniform quality image and a field-emission electron source imaging apparatus capable of capturing a uniform quality image.

Now, the auxiliary electrode 8 will be described in detail.

The auxiliary electrode 8 can be produced using a silicon substrate by an MEMS (micro electro mechanical system) technique, which is a semiconductor technology. In other words, a silicon substrate whose resistance has been lowered by doping into an N type or a P type can be subjected to fine processing using a semiconductor technology, thereby forming the through holes 90 as shown in FIG. 3.

The above-described production of the auxiliary electrode 8 using a silicon substrate by the MEMS technique, which is the semiconductor technology, has the following advantages.

First, fine processing on the order of micrometers and sub-micrometers using the semiconductor technology becomes possible. Thus, in the case of a VGA field-emission electron source apparatus including a large number of (for example, 100) cold cathode elements 15 in a single cell of a square about 20 μm per side, for example, the diameter D of the opening 91 of the auxiliary electrode 8 is about 16 μm, for example, so that its forming accuracy needs to be on the order of sub-micrometers. By using the MEMS technique, such fine processing can be carried out.

Second, as the assembly of the auxiliary electrode 8 and the field-emission electron source array also has to be highly accurate, using the MEMS technique makes it possible to form the auxiliary electrode 8 in a highly accurate manner and assemble the auxiliary electrode 8 and the field-emission electron source array in a highly accurate manner, thus achieving a field-emission electron source apparatus with an excellent quality.

Third, the silicon substrate can be used to achieve the same coefficient of thermal expansion as that of the semiconductor substrate 6 that is produced also using a silicon substrate and on which the field-emission electron source array is to be formed.

For ensuring reliability such as accuracy, it is preferable that the field-emission electron source array partially or entirely is produced using a silicon substrate by the semiconductor technology. Such a system also is advantageous in terms of cost because the above-noted semiconductor technology is common now and the equipment needed therefor is readily available in the market.

It is advantageous in terms of thermal expansion to form the auxiliary electrode 8 of the same material as the substrate on which the field-emission electron source array is to be formed. For example, the field-emission electron source apparatus becomes less likely to break due to thermal expansion, and burning such as baking for degassing can be carried out at high temperatures when assembling the field-emission electron source apparatus.

The spacer portion 8a is formed as one piece with the auxiliary electrode 8, and the spacer portion 8a of the auxiliary electrode 8 is placed directly on the semiconductor substrate 6 on which the field-emission electron source array is formed. In this way, accuracy of the distance between the field-emission electron source array and the auxiliary electrode 8 can be enhanced. This allows the spacer portion 8a to fulfill effectively its function of maintaining the distance between the field-emission electron source array and the openings 91 of the plurality of through holes 90 formed in the trimming portion 9 of the auxiliary electrode 8 in a highly accurate manner.

Also, the spacer portion 8a is formed so as to be connected to the periphery of the auxiliary electrode 8 and project beyond the trimming portion 9. This spacer portion 8a is brought into close contact with the semiconductor substrate 6, whereby a first space 51 containing the target 3 and a second space 52 containing the field-emission electron source array are separated substantially in the vacuum container. Thus, it is possible to suppress the influence of the gas generated outside the second space 52 on the field-emission electron source array.

In other words, the target 3 and glass members such as the wall part 4 are present in the first space 51, and the electron beam 11b or scattered electrons may impact on them so as to generate gas. Especially during driving the field-emission electron source apparatus, it is very likely that electrons in the electron beam 11b not only impact on the target 3 but also become scattered and impact on the glass members such as the wall part 4, resulting in gas generation.

For example, the space in the vacuum container in the conventional field-emission electron source apparatus shown in FIG. 14 is separated by the shield grid electrode 120 fixed to the wall part 116 into the first space 135 containing the photoelectric conversion target 114 and the second space 136 containing the field-emission electron source array 129. The third space 137 inside the getter pump container 131 receiving the getter pump 132 is connected to the second space 136 via the vent hole 130 formed in the back panel 117. Thus, gas generated from the photoelectric conversion target 114 exposed in the first space 135 and gas generated from the glass members such as the wall part 116 and the back panel 117 always pass through the second space 136 before reaching the third space 137. Accordingly, these gases are adsorbed by the field-emission electron source array 129, so that serious problems such as deteriorating emission characteristics may arise.

Further, ions generated by the impact of the electron beam or the scattered electrons on the photoelectric conversion target 114 or the peripheral glass members approach the vicinity of the field-emission electron source array 129, which may cause a problem in terms of withstand voltage characteristics, for example, discharge may occur between the cold cathode elements 124 and the gate electrodes 128.

On the other hand, in Embodiment 1 of the present invention, the getter pump 80 is disposed in the first space 51 containing the target 3, which tends to emit the gas greatly. The gas generated inside the first space 51 containing the target 3 and the glass members such as the wall part 4 reaches the getter pump 80 without passing through the second space 52 containing the field-emission electron source array. Consequently, compared with the conventional field-emission electron source apparatus described above, it is possible to suppress the influence of the gas generated in the vacuum container on the emission characteristics of the field-emission electron source array.

Moreover, since the first space 51 containing the getter pump 80 and the second space 52 containing the field-emission electron source array 10 are separated substantially, it becomes easier to form the getter pump 80 using an evaporative getter. In other words, even if an electric current is passed through the evaporative getter so as to disperse a getter material, thus forming a getter film on the peripheral members, it is possible to prevent the dispersed getter material from adhering to the field-emission electron source array 10.

Also, dissociated ions generated by the impact of the electron beam or the scattered electrons on the target 3 and the exposed glass surface are trapped or repelled by the auxiliary electrode 8 maintained at a constant electric potential due to the electric charges of these ions. Therefore, it is difficult for the ions to pass through the through holes 90 formed in the auxiliary electrode 8, enter the second space 52 containing the field-emission electron source array 10 and reach the field-emission electron source array 10.

In this manner, the dissociated ions are prevented from approaching the field-emission electron source array 10, thereby making it possible to avoid the problems in terms of withstand voltage characteristics caused by the approach of the dissociated ions to the vicinity of the field-emission electron source array 10, for example, the discharge between the cold cathode elements and the gate electrodes or the discharge between the auxiliary electrode 8 and the field-emission electron source array 10.

Then, this effect becomes more noticeable with an increase in the length of the electron beam passageway (namely, the thickness of the auxiliary electrode) relative to the opening diameter of the through hole. Accordingly, it is more preferable that the ratio of the length of the electron beam passageway to the opening diameter of the through hole is larger.

In the present invention, the second space 52 containing the field-emission electron source array 10 and the first space 51 containing the target 3 and the getter pump 80 are separated substantially by the auxiliary electrode 8. Here, “separated substantially” means that a gas flow path that allows the gas generated from the target 3 to be absorbed by the getter pump 80 without passing through the second space 52 containing the field-emission electron source array 10 is formed in the vacuum container. Therefore, it does not matter if the plurality of through holes 90 are formed in the trimming portion 9 of the auxiliary electrode 8 between the field-emission electron source array 10 and the target 3. Furthermore, a hole or a gap that connects the first space 51 and the second space 52 other than the through holes 90 may be formed in the auxiliary electrode 8 (for example, the trimming portion 9 or the spacer portion 8a) or a member for holding the auxiliary electrode 8. In other words, the gas or ions generated from the target 3 and the glass members such as the wall part 4 only have to be absorbed by the getter pump 80 without passing through the second space 52 containing the field-emission electron source array 10. For example, it is preferable that a spatial conductance of a portion with the smallest cross-section in a path that leads from the first space 51 containing the target 3 and the glass members such as the wall part 4 to the getter pump 80 without passing through the second space 52 containing the field-emission electron source array (a minimum path portion), i.e., (cross-section of the minimum path portion)/(path length of the minimum path portion) C1, is sufficiently larger than that of a portion with the largest cross-section in a path that leads from the first space 51 to the second space 52 (a maximum path portion; corresponding to the through hole 90 in the present embodiment), i.e., (cross-section of the maximum path portion)/(path length of the maximum path portion) C2. More specifically, it is preferable that the above-noted conductances C1 and C2 satisfy C1/C2≧10.

The embodiment described above has been directed to the Spindt-type in which the field-emission electron source includes the cold cathode elements 15 with sharpened tips and the gate electrodes 12 provided with openings surrounding these tips as an example. However, the field-emission electron source of the present invention is not limited to this. For example, it also may be a field-emission electron source of an MIM (metal insulator metal) type in which an insulating layer is formed between cathode electrodes and gate electrodes, and a voltage is applied to the insulating layer, thereby emitting electrons by a tunnel effect, that of an SCE (surface conduction electron source) type in which a minute gap is provided between cathode electrodes and emitter electrodes, and a voltage is applied between these electrodes, thereby emitting electrons from the minute gap, and that using a carbonaceous material such as DLC (diamond like carbon) or CNT (carbon nanotube) for an electron source.

Furthermore, although the front panel 1 has a circular shape when viewed from the Z-axis direction in the embodiment described above, the present invention is not limited to this. For example, the front panel 1 may have a quadrangular shape.

Also, although the auxiliary electrode 8 is placed on the semiconductor substrate 6 on which the field-emission electron source array 10 is formed in the embodiment described above, the present invention is not limited to this. For example, it also may be possible to form a field-emission electron source array of the Spindt type or the like directly on the back panel 5 by a semiconductor processing technique and place the auxiliary electrode 8 on the back panel 5 on which the field-emission electron source array is formed.

Further, the embodiment described above has illustrated the example in which the getter pump 80 for adsorbing and removing excess gas and maintaining the inside of the vacuum container under high vacuum is disposed inside the first space 51 containing the target 3 in the vacuum container formed of the front panel 1, the back panel 5 and the wall part 4. However, the present invention is not limited to this.

For example, as shown in FIG. 8, a getter box constituted by a getter box lateral wall portion 47 and a getter box bottom portion 48 may be provided on a surface of the back panel 5 opposite to the side on which the semiconductor substrate 6 is mounted, and a getter 50 may be arranged inside a third space 53 in this getter box. A getter lead 49 connected to the getter 50 is led out of the getter box. By passing a predetermined electric current through this getter lead 49 from the outside of the field-emission electron source apparatus, the getter 50 is dispersed so as to adhere to an inner wall of the getter box. In this way, the getter pump for adsorbing and removing excess gas inside the vacuum container is formed.

A vent hole 46 is formed in a region of the back panel 5 where the semiconductor substrate 6 is not mounted, and the first space 51 and the third space 53 containing the getter pump are connected via this vent hole 46.

In the field-emission electron source apparatus illustrated in FIG. 8, since a vacuum capacity in the vacuum container can be increased, it is possible to suppress the deterioration of the degree of vacuum caused by the gas generated in the vacuum container. Also, the gas generated in the first space 51 containing the target 3 and the glass members such as the wall part 4 can reach the third space 53 containing the getter pump without passing through the second space 52 containing the field-emission electron source array 10. Therefore, it is possible to suppress the influence of the gas generated in the vacuum container on the emission characteristics of the field-emission electron source array 10.

Moreover, a getter pump further may be arranged inside the second space 52 containing the field-emission electron source array 10. This makes it possible to suppress the influence of a slight amount of gas that may be generated between the field-emission electron source array 10 and the auxiliary electrode 8.

Furthermore, although the auxiliary electrode is placed directly on the semiconductor substrate 6 on which the field-emission electron source array is formed in the example described above, the present invention is not limited to this. For example, as shown in FIG. 9, a focusing electrode 26 for pre-focusing an electron beam may be provided between the auxiliary electrode 8 and the semiconductor substrate 6. In this case, since the second space 52 containing the field-emission electron source array 10 and the first space 51 containing the target 3 and the getter pump 80 also are separated by the auxiliary electrode 8, the gas generated in the first space 51 containing the target 3 and the glass members such as the wall part 4 can be led to and adsorbed and removed by the getter pump without passing through the second space 52 containing the field-emission electron source array 10. In other words, there is no difference from the above-described example in that the deterioration of the degree of vacuum can be suppressed.

As described above, in Embodiment 1 of the present invention, the spacer portion 8a that is formed as one piece with the auxiliary electrode 8 is placed directly on the semiconductor substrate 6 provided with the field-emission electron source array 10, so that the distance from the trimming portion 9 of the auxiliary electrode 8 to the field-emission electron source array 10 can be set in a highly accurate manner. Also, in the vacuum container, the first space 51 containing the target 3 and the second space 52 containing the field-emission electron source array 10 can be separated. Then, by separating the space containing the getter pump and the second space 52, the gas generated in the first space 51 containing the target 3 and the glass members such as the wall part 4 reaches the getter pump without passing through the second space 52. Therefore, it is possible to suppress an adverse influence of the gas generated in the vacuum container on the field-emission electron source array 10.

Also, the dissociated ions generated by the impact of the electron beam or the scattered electrons on the target 3 and the exposed glass surface are trapped or repelled by the auxiliary electrode 8 maintained at a constant electric potential due to the electric charges of these ions. Therefore, it is difficult for the ions to pass through the through holes 90 formed in the auxiliary electrode 8 and reach the field-emission electron source array 10. Accordingly, it is possible to avoid the problems in terms of withstand voltage characteristics caused by the approach of the dissociated ions to the vicinity of the field-emission electron source array 10, for example, the discharge between the cold cathode elements and the gate electrodes or the discharge between the auxiliary electrode 8 and the field-emission electron source array 10.

Consequently, a highly-reliable field-emission electron source apparatus can be achieved.

### Embodiment 2

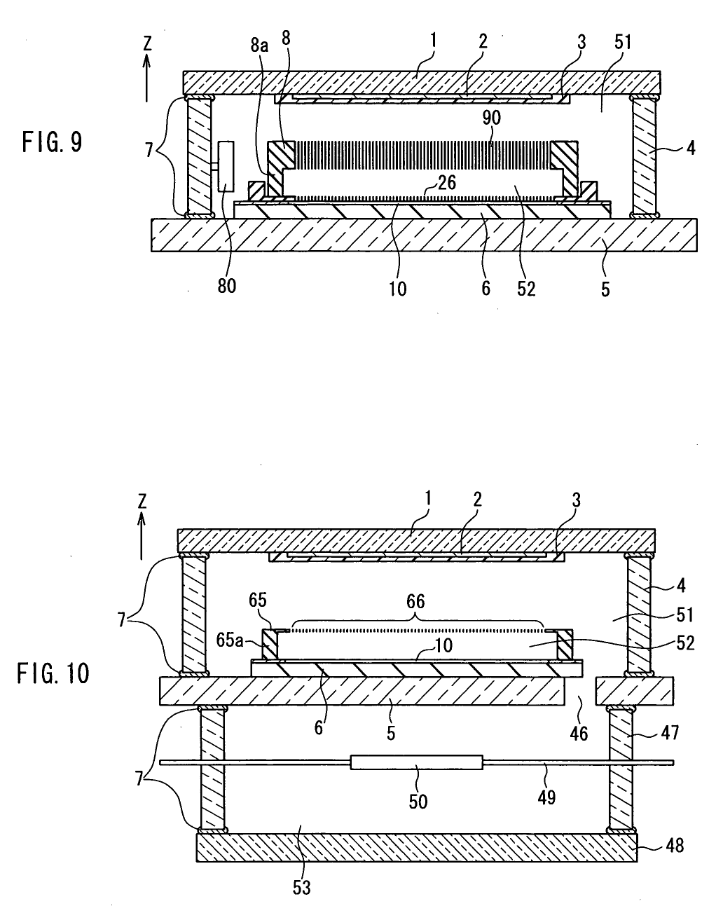

FIG. 10 is a sectional view showing a field-emission electron source apparatus according to Embodiment 2 of the present invention.

As shown in FIG. 10, the field-emission electron source apparatus according to Embodiment 2 of the present invention is different from that according to Embodiment 1 shown in FIG. 8 in that an auxiliary electrode 65 for separating the first space 51 containing the target 3 and the second space 52 containing the field-emission electron source array has a thin trimming portion 66. In the following, the description of portions that are the same as those in Embodiment 1 will be omitted.

The trimming portion 66 of the auxiliary electrode 65 is a metal thin film provided with a large number of openings, and fixed to a spacer portion 65a, which is a metallic frame, by welding or the like. Under an outward tension from the spacer portion 65a, the trimming portion 66 forms a flat surface.

Similarly to FIG. 8, the second space 52 that is formed of the semiconductor substrate 6 and the trimming portion 66 and contains the field-emission electron source array 10 is separated from the first space 51 containing the target 3 by the auxiliary electrode 65. The first space 51 is connected to the third space 53 containing the getter pump via the vent hole 46 formed in a region of the back panel 5 where the semiconductor substrate 6 is not mounted.

This allows the gas generated by the impact of the electron beam on the target 3 and the gas generated by the impact of the scattered electron beam on the glass members such as the wall part 4 in the first space 51 to be led to the third space 53 containing the getter pump and absorbed and removed by the getter pump without passing through the second space 52 containing the field-emission electron source array 10. Thus, it is possible to suppress the degradation of the emission characteristics caused by malfunction or deterioration of the field-emission electron source array 10 due to the gas generated in the vacuum container.

The spacer portion 65a of the auxiliary electrode 65 is placed on the semiconductor substrate 6 via an electrically conductive material such as gold. A voltage is supplied to the trimming portion 66 from the semiconductor substrate 6 via this electrically conductive material and the spacer portion 65a.

This makes it possible to supply a voltage to the auxiliary electrode from the semiconductor substrate 6, thus eliminating the need for separate wire bonding for supplying the voltage. Thus, the cost for wire bonding can be saved, and failures such as fallen wires can be avoided in the case of wire bonding.

Embodiment 2 of the present invention is the same as Embodiment 1 in that the second space 52 containing the field-emission electron source array is separated from the first space 51 containing the target 3 and the third space 53 containing the getter pump by the auxiliary electrode and that the spacer portion of the auxiliary electrode and the semiconductor substrate 6 are connected via the electrically conductive material so that a voltage is supplied from the semiconductor substrate 6 to the trimming portion via this electrically conductive material and the spacer portion. Although the trimming portion is thin in Embodiment 2 of the present invention, it is possible to achieve the same trimming effect as that in Embodiment 1.

### Embodiment 3

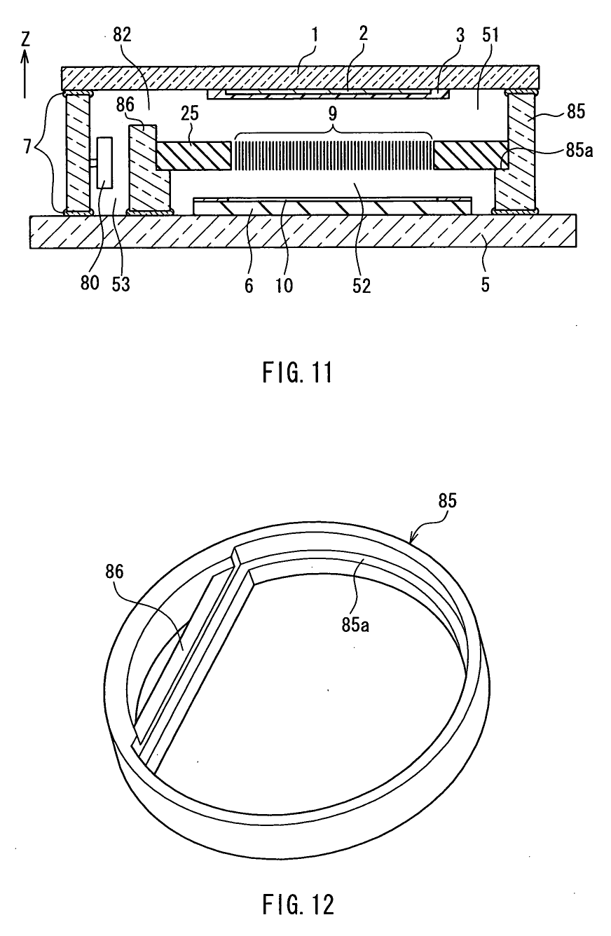

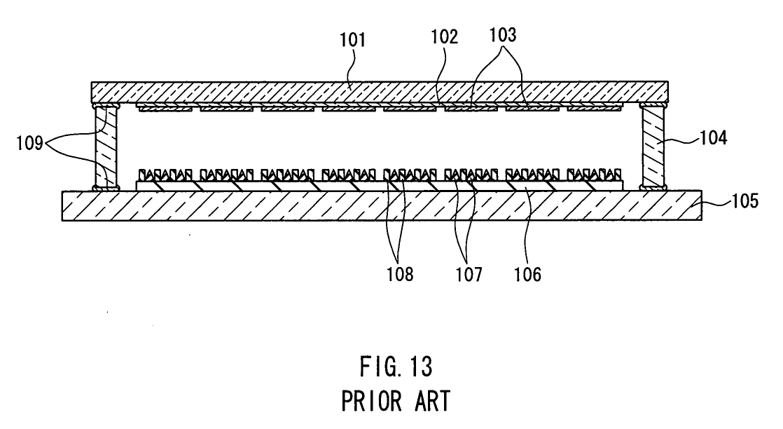

FIG. 11 is a sectional view showing a field-emission electron source apparatus according to Embodiment 3 of the present invention. FIG. 12 is a perspective view showing a wall part 85 in the field-emission electron source apparatus according to Embodiment 3 of the present invention.

The wall part 85 in the present embodiment includes a partition wall 86 bridging two points on its annular outer cylinder. An inner peripheral surface of the wall part 85 and the partition wall 86 are provided with a step 85a, which supports an auxiliary electrode 25 having no spacer portion.

Similarly to Embodiment 1, the vacuum container is formed of the front panel 1, the back panel 5 and the wall part 85. In the present embodiment, the first space 51 containing the target 3, the second space 52 containing the field-emission electron source array 10 and the third space 53 containing the getter pump 80 are formed in the vacuum container. The first space 51 containing the target 3 and the second space 52 containing the field-emission electron source array 10 are connected only via a plurality of through holes formed in the auxiliary electrode 25 and separated by the auxiliary electrode 25 in other portions. The first space 51 containing the target 3 and the third space 53 containing the getter pump 80 are connected via a gap 82 formed between the partition wall 86 and the front panel 1.

In Embodiment 3 of the present invention, the gas generated by the impact of the electron beam on the target 3 and the gas generated by the impact of the scattered electron beam on the glass members such as the wall part 85 in the first space 51 move to the third space 53 through the gap 82 and are adsorbed and removed by the getter pump 80 without passing through the second space 52 containing the field-emission electron source array 10. Thus, it is possible to suppress the degradation of the emission characteristics caused by malfunction or deterioration of the field-emission electron source array 10 due to the gas generated in the vacuum container.

The present invention is applicable to any fields with no particular limitations and can be utilized in, for example, a field-emission electron source display apparatus and a field-emission electron source imaging apparatus.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A field-emission electron source apparatus comprising:
a field-emission electron source array;
a target for performing a predetermined operation using an electron beam emitted from the field-emission electron source array; and
an auxiliary electrode that is disposed between the field-emission electron source array and the target and provided with a plurality of through holes through which the electron beam emitted from the field-emission electron source array passes;
wherein the field-emission electron source apparatus further comprises
a vacuum container that receives the field-emission electron source array, the target and the auxiliary electrode, and
a getter pump that is disposed in the vacuum container and absorbs and removes excess gas, and
a space containing the field-emission electron source array and a space containing the target and the getter pump are separated substantially by the auxiliary electrode so that gas generated from the target is absorbed by the getter pump without passing through the space containing the field-emission electron source array.

2. The field-emission electron source apparatus according to claim 1, further comprising a substrate on which the field-emission electron source array is formed,
wherein the auxiliary electrode has a spacer portion that is formed as one piece with the auxiliary electrode and spaces out the field-emission electron source array and openings of the plurality of through holes from each other, and
the auxiliary electrode is provided on the substrate via the spacer portion.

3. The field-emission electron source apparatus according to claim 2, wherein the spacer portion and the substrate are joined using an electrically conductive material, and
a voltage is supplied to at least part of the auxiliary electrode from the substrate via the electrically conductive material.
